(19) United States
(12) Patent Application Publication
(10) Pub. No.: US 2024/0276982 A1
(43) Pub. Date: Aug. 22, 2024

(54) USE OF HIGHER FATTY ALCOHOL IN ASPECTS OF DISEASE AND PEST PREVENTION AND YIELD INCREASEMENT OF CORN

(71) Applicant: ZHUHAI RUNNONG SCIENCE AND TECHNOLOGY CO. LTD, Zhuhai (CN)

(72) Inventors: Xiaoming Peng, Zhuhai (CN); Yunhao Sun, Zhuhai (CN); Dianxian Cai, Zhuhai (CN); Guohui Yu, Zhuhai (CN); Di Qin, Zhuhai (CN)

(21) Appl. No.: 18/651,696

(22) Filed: May 1, 2024

Related U.S. Application Data
(63) Continuation of application No. PCT/CN2021/128766, filed on Nov. 4, 2021.

(51) Int. Cl. A01N 31/02; A01G 22/20; A01P 21/00

(52) U.S. Cl. CPC A01N 31/02; A01G 22/20; A01P 21/00

(57) ABSTRACT

Disclosed is a use of a higher fatty alcohol in preparing a preparation for improving transcription levels of genes associated with synthesis pathways of jasmonic acid, cutin, and wax of corn plants. By using a water emulsion containing the higher fatty alcohol, the synthesis pathways of the cutin, the wax, and the jasmonic acid in metabolic pathways of the corn plants are affected, rust disease resistance, pest resistance, and drought resistance of the corn plants can be effectively improved, and a yield of the corn plants is increased.

### CROSS-REFERENCE TO RELATED APPLICATIONS

The present application is a Continuation application of PCT Application No. PCT/CN2021/128766, filed on Nov. 4, 2021, the entire contents of which are hereby incorporated by reference.

### TECHNICAL FIELD

The present disclosure relates to a use of higher fatty alcohol in aspects of disease and pest prevention and yield increasement of corn plants.

### DESCRIPTION OF THE PRIOR ART

Corn is an important source of human food and raw materials for animal feeding, and the corn is also an important food crop and economic crop in China. In 2020-2021, a planting area of corn plants in China is about 41.26 million hectares, and a yield is about 272 million tons, accounting for about 35.3% of a total grain planting area. The yield of the corn plants is related to a food security in China.

Growth and development, quality and the yield of the corn plants are seriously affected by pests such as corn plants rust disease, thrips, armyworms and corn plants borers, as well as drought adversity during critical periods of corn plants growth. In production, some problems can be solved by spraying chemical pesticides or manual adjustment such as irrigation, however, both economic costs and environmental costs are faced with an increase.

### SUMMARY OF THE DISCLOSURE

In order to overcome shortcomings of the prior art, a purpose of the present disclosure is to provide an application of higher fatty alcohol in aspects of disease and pest prevention and yield increasement of corn plants.

In order to solve the above problems, the present disclosure provides the following technical solution.

The present disclosure provides a use of a higher fatty alcohol in preparing a preparation for increasing transcription levels of genes associated with a synthesis pathway of jasmonic acid of corn plants, and a use in an aspect of preventing insect pests of the corn plants is achieved by increasing the transcription levels of genes associated with the synthesis pathway of the jasmonic acid of the corn plants through the higher fatty alcohol.

On the other hand, the present disclosure provides a use of a higher fatty alcohol in preparing a preparation for increasing transcription levels of genes associated with synthesis pathways of cutin and wax of corn plants, and a use in an aspect of reducing erosion of pests and diseases is achieved by increasing the transcription levels of genes associated with the synthesis pathways of the cutin and the wax through the higher fatty alcohol.

On the other hand, the present disclosure provides a use of a higher fatty alcohol in preparing a preparation for increasing transcription levels of genes associated with synthesis pathways of cutin and wax of corn plants, and a use in an aspect of increasing a yield of the corn plants is achieved by increasing the transcription levels of genes associated with the synthesis pathways of the cutin and the wax through the higher fatty alcohol.

On the other hand, the present disclosure provides a use of a higher fatty alcohol in preparing a preparation for increasing transcription levels of genes associated with synthesis pathways of cutin and wax of corn plants, and a use in an aspect of drought resistance of the corn plants is achieved by increasing the transcription levels of genes associated with the synthesis pathways of the cutin and the wax through the higher fatty alcohol.

On the other hand, the present disclosure provides a use of a higher fatty alcohol in preparing a preparation for increasing transcription levels of genes associated with synthesis pathways of cutin and wax of corn plants, and a use in an aspect of rust disease resistance of the corn plants is achieved by increasing the transcription levels of genes associated with the synthesis pathways of the cutin and the wax through the higher fatty alcohol.

In the present disclosure, the higher fatty alcohol is one of dodecanol and cetyl alcohol or a mixture of dodecanol and cetyl alcohol.

In one embodiment, the preparation is a water emulsion, and the water emulsion includes the higher aliphatic alcohol, an emulsifier, a thickener and water.

The preparation containing the higher fatty alcohol of the present disclosure is not limited to the water emulsion, all dosage forms as long as adopt an inventive concept of the present disclosure, are applicable, for example, wettable powder, emulsion, sprayable solution, concentrated emulsion, aerosol and seed coating agent.

Compared with the prior art, beneficial effects of the present disclosure are as follows.

Using the water emulsion containing the higher fatty alcohol to the corn plants, the synthesis pathways of cutin, wax, and jasmonic acid in the metabolic pathways of the corn plants can be significantly affected; and in an actual agricultural production, the rust disease resistance and insect resistance, the drought resistance, and the quality and yield of the corn plants can be effectively improved.

### DESCRIPTION OF EMBODIMENTS

### Example 1

A water emulsion containing a higher fatty alcohol is provided in the example, and the water emulsion consists of the following components in a weight percentage: 24% dodecanol, 3% cetyl alcohol, 3% emulsifier, 5% thickener, and the rest is water.

In the example, the emulsifier is fatty acid polyoxyethylene ester, and the thickener is methyl cellulose.

A method of preparing the water emulsion is also provided in the example, including the following steps:

Putting the dodecanol and the cetyl alcohol into a container and heating to 60 degrees to melt; then adding the emulsifier to the container, processing through a high shear homogenizer, and rotating for 10 minutes with a rotating speed of 5000 rotation per minute; then adding 60 degree water to the container, processing through the high shear homogenizer, and rotating for 10 minutes with a rotating speed of 10000 rotation per minute; cooling down to 40 degrees, and then adding the thickener to the container, processing by the high shear homogenizer, and rotating for 30 minutes with a rotating speed of 10000 rotation per minute, the water emulsion is obtained.

### Example 2

A water emulsion containing a higher fatty alcohol is provided in the example, and the water emulsion consists of the following components in a weight percentage: 24% dodecanol, 3% emulsifier, 5% thickener, and the rest is water.

In the example, the emulsifier is fatty acid polyoxyethylene ester, and the thickener is methyl cellulose.

A method of preparing the water emulsion is also provided in the example, including the following steps:

Putting the dodecanol into a container and heating to 60 degrees to melt; then adding the emulsifier to the container, processing through a high shear homogenizer, and rotating for 10 minutes with a rotating speed of 5000 rotation per minute; then adding 60 degree water to the container, processing through the high shear homogenizer, and rotating for 10 minutes with a rotating speed of 10000 rotation per minute; cooling down to 40 degrees, and then adding the thickener to the container, processing by the high shear homogenizer, and rotating for 30 minutes with a rotating speed of 10000 rotation per minute, the water emulsion is obtained.

### Example 3

A water emulsion containing a higher fatty alcohol is provided in the example, and the water emulsion consists of the following components in a weight percentage: 3% cetyl alcohol, 3% emulsifier, 5% thickener, and the rest is water.

In the example, the emulsifier is fatty acid polyoxyethylene ester, and the thickener is methyl cellulose.

A method of preparing the water emulsion is also provided in the example, including the following steps:

Putting the cetyl alcohol into a container and heating to 60 degrees to melt; then adding the emulsifier to the container, processing through a high shear homogenizer, and rotating for 10 minutes with a rotating speed of 5000 rotation per minute; then adding 60 degree water to the container, processing through the high shear homogenizer, and rotating for 10 minutes with a rotating speed of 10000 rotation per minute; cooling down to 40 degrees, and then adding the thickener to the container, processing by the high shear homogenizer, and rotating for 30 minutes with a rotating speed of 10000 rotation per minute, the water emulsion is obtained.

### Example 4

A water emulsion is provided in the example, and the water emulsion consists of the following components in a weight percentage: 3% emulsifier, 5% thickener, and the rest is water.

In the example, the emulsifier is fatty acid polyoxyethylene ester, and the thickener is methyl cellulose.

Putting the emulsifier to a container, processing through a high shear homogenizer, and rotating for 10 minutes with a rotating speed of 5000 rotation per minute; then adding 60 degree water to the container, processing through the high shear homogenizer, and rotating for 10 minutes with a rotating speed of 10000 rotation per minute; cooling down to 40 degrees, and then adding the thickener to the container, processing by the high shear homogenizer, and rotating for 30 minutes with a rotating speed of 10000 rotation per minute, the water emulsion is obtained.

### Example 5: An Effect of the Water Emulsion Containing the Higher Fatty Alcohol on Transcription of Genes Associated with Fatty Acid Metabolic Pathways of Corn Plants

The fatty acid metabolic pathway is involved in a synthesis process of plant physiological immune substances such as jasmonic acid and physical immune barriers such as cutin and wax. Resistance to diseases and pests of plants can be significantly improved by up-regulating a type of pathway as the fatty acid metabolic pathway. The cutin and the wax are a first barrier between plants and an outside world, and also a first layer structure of a plant physiological signal transduction. Pathogenic fungi such as rust diseases and insect pests that cause serious damage can be effectively defended by up-regulating the type of pathway, thereby reducing an occurrence of the diseases and pests significantly. And a resistance of plant leaves to strong light can be increased and a damage of ultraviolet rays to a photosynthetic system can be reduced by up-regulating the type of pathway, thereby effectively regulating transpiration under drought conditions to achieve an effect of promoting a yield of the plants. Jasmonic acid and derivatives thereof are key physiological hormone substances for insect resistance of plants, therefore, a defense capability of the corn plants against the pests can be improved by up-regulating a type of synthetic pathways of the cutin, wax and jasmonic acid in the fatty acid metabolic pathway of the corn plants.

Samples of the corn plants are treated with the water emulsion containing the higher fatty alcohol (different ratios of higher fatty aliphatics) of the present disclosure, a transcriptome sequencing is performed, and an effect of the water emulsion of the present disclosure on the transcription of genes associated with synthesis pathways of cutin, wax and jasmonic acid in metabolic pathways of the corn plants is analyzed.

### (1) Fatty Alcohol Sample: The Water Emulsion Containing the Higher Fatty Alcohol (Different Ratios of Higher Fatty Aliphatics) of the Present Disclosure Listed in Table 1.

TABLE 1
sample numbers

| | sample numbers | | | | |
|---|---|---|---|---|---|
| | sample | sample | sample | sample | sample |
| | S-component | A-component | B-component | C-component | CK(comparison) |
| raw materials | Example 1 | Example 2 | Example 3 | Example 4 | clean water |

### (2) Test Plants: Corn Plants (Zhu Yu Sweet No. 1).

Culture conditions: 70/0 μmol m⁻² s⁻¹ (light/dark cycle light intensity), 14 hours/10 hours (time of light/dark cycle), 27° C./24° C., 70% relative humidity, four weeks old.

### (3) Sample Processing and Data Collecting.

Healthy plants with similar growth status in a group are selected, and leaves are sprayed using dilutions of the above samples (900 times diluted with water), until the leaves are completely covered with a liquid film. The comparison group is sprayed with the same amount of sterile water for diluting a stock solution. A second spraying treatment is performed after 48 hours. Three biological replicates are provided in each group.

72 hours after a first treatment, 4 grams of leaf samples are collected from each group. The leaf samples are quickly frozen in liquid nitrogen for 3 minutes, kept warm with dry ice and sent to a laboratory of Wuhan Metware Biotechnology Inc. for metabolomics sequencing (All metabolome and transcriptome sequencing data below are provided by Wuhan Metware Biotechnology Inc.).

(4) An Effect of a Treatment on the Transcription of Genes Associated with the Fatty Acid Metabolic Pathways of the Corn Plants.

After corn plant leaves are treated with a mixed preparation of dodecanol and cetyl alcohol (S), a dodecanol separate preparation (A), a cetyl alcohol separate preparation (B), the emulsifier (C) and CK (clean water) for 72 hours, transcription differences of genes associated with fatty acid metabolic pathways during a physiological process are shown in Table 2. A detection result shows that compared with tissues treated with the emulsifier (C), transcriptional levels of genes associated with fatty acid metabolic pathways (involve the synthesis pathways of the cutin, wax and jasmonic acid) of tissues treated with the mixed sample (S), the dodecanol separate preparation (A) and the cetyl alcohol separate preparation (B) are up-regulated significantly, increasing by 1250.01, 625.01 and 303.03 times respectively. However, compared with the comparison group treated with clean water, the transcriptional levels of genes associated with the fatty acid metabolic pathways of the corn plant leaves treated with the emulsifier (C) are not significantly up-regulated. The detection result indicates that the dodecyl alcohol, the cetyl alcohol and the mixture of the dodecyl alcohol and the cetyl alcohol have a physiological activity of significantly up-regulating the transcription of genes associated with the fatty acid metabolic pathways of the corn plants, while the emulsifier does not have the physiological activity.

TABLE 2
a ratio of the transcriptional levels of genes associated with the fatty acid
metabolic pathways (involves the synthesis pathways of the cutin, wax and jasmonic
acid) of the corn plant leaves in each treatment group (increase multiple)

| | corn plants | corn plants | corn plants | corn plants |
|---|---|---|---|---|
| gene encoding | A component/ | B component/ | S component/ | C component/ |
| protein name | C component | C component | C component | comparison |
| long-chain acyl-CoA | 625.01 | 303.03 | 1250.01 | <2.00 |
| synthetase | | | | |
| acyl-CoA oxidase | 2.44 | 2.16 | 3.03 | <2.00 |
| acetyl-CoA | 2.38 | 4.55 | 2.44 | <2.00 |
| acyltransferase | | | | |

### Example 6: An Effect of the Water Emulsion Containing the Higher Fatty Alcohol in a Field Production of Fresh Corn Plants

Sampling: sample (S) is the water emulsion containing the higher fatty alcohol prepared by Example 1.

Crop: the fresh corn plants (Zhu Yu sweet No. 1).

Location: Modern Agricultural Development Research Center of Zhuhai City, Guangdong Province.

Method: selecting a 10-mu test group and a 10-mu comparison group at a production base to produce according to Table 3. mu is an area unit, and 1 mu equals about 0.067 hectares.

TABLE 3
a test scheme of the higher fatty alcohol and the mixture
of the present disclosure used in the fresh corn plants

| serial | | | |
|---|---|---|---|
| number | processing period | test group | comparison group |
| 1 | jointing stage | The sample (S) is diluted 900 times | At the same time as the test |
| | | with water and then sprayed once. | group is treated, the same |
| | | sample dosage: 30 mL/mu, time | amount of clean water is |
| | | | sprayed. |
| 2 | before tasseling | The sample (S) is diluted 900 times | At the same time as the test |
| | | with water and then sprayed once. | group is treated, the same |
| | | sample dosage: 30 mL/mu, time | amount of clean water is |
| | | | sprayed. |
| 3 | flowering and | The sample (S) is diluted 900 times | At the same time as the test |
| | heading stage | with water and then sprayed once. | group is treated, the same |
| | | sample dosage: 30 mL/mu, time | amount of clean water is |
| | | | sprayed. |

A comparison of the use effects.

During a whole growth process, the fresh corn plants of the test group treated with the water emulsion containing the higher fatty alcohol of the present disclosure has no obvious disease damage; an appearance of the fresh corn plants of the test group exhibits obvious advantages in growth vigour and a growth feature, a plant type is taller, and colour of leaves is darker and shiny. During a growth process of the fresh corn plants of the comparison group, an appearance of the fresh corn plants is obviously weaker in the growth vigour and growth feature, insect pests of corn plant borer, corn plant aphids and the like are found, and a damage rate of the insect pests is 11.0%.

During the test of the corn plants, the test group and the comparison group encounter cold weather during the flowering stage, a southern rust disease is found in the comparison group, accounting for 35.0% of total corn plants in the comparison group. Statistics are performed by survey statistical methods of crop diseases, a disease index of the corn plants rust disease in the comparison group is 0.435, and in the test group is 0.0.

TABLE 4
a result of the water emulsion containing the higher fatty alcohol
of the present disclosure using in the fresh corn plants

| serial | | test | |
|---|---|---|---|
| number | item | group | comparison group |
| 1 | insect pest | no | corn plant borer and corn |
| | | | plant aphids are found, |
| | | | and the damage rate of the |
| | | | insect pests is 11.0%. |
| 2 | yield per mu (kg) | 1183.8 | 1011.8 |
| 3 | commercialized yield | 1102.8 | 881.6 |
| | per mu (kg) | | |
| 4 | commercialization | 93.2 | 87.13 |
| | rate (%) | | |

During the whole growth process, the fresh corn plants of the test group treated with the water emulsion containing the higher fatty alcohol of the present disclosure has no obvious disease damage, the plant type is taller, and the colour of leaves is darker and shiny. A yield increase rate of commercial fresh corn plants reaches 20.06%.

### Example 7: An Use Effect of the Water Emulsion Containing the Higher Fatty Alcohol in a Field Production of Feed Corn Plants

Sampling: sample (S) is the water emulsion containing the higher fatty alcohol prepared by Example 1.

Crop: the feed corn plants (Ya Yu No. 8).

Location: Xijiang Town, Lianzhou City, Guangdong Province.

Method: selecting a 5-mu test group and a 5-mu comparison group at a production base to produce according to Table 5.

TABLE 5
a test scheme of the higher fatty alcohol and the mixture
of the present disclosure used in the feed corn plants

| serial | processing | | |
|---|---|---|---|
| number | period | test group | comparison group |
| 1 | jointing stage | The sample (S) is diluted 900 times | At the same time as the |
| | | with water and then sprayed once. | test group is treated, the |
| | | sample dosage: 40 mL/mu, time | same amount of clean |
| | | | water is sprayed |
| 2 | before | The sample (S) is diluted 900 times | At the same time as the |
| | tasseling | with water and then sprayed once. | test group is treated, the |
| | | sample dosage: 40 mL/mu, time | same amount of clean |
| | | | water is sprayed |
| 3 | flowering | The sample (S) is diluted 900 times | At the same time as the |
| | and heading | with water and then sprayed once. | test group is treated, the |
| | stage | sample dosage: 40 mL/mu, time | same amount of clean |
| | | | water is sprayed |

A comparison of the use effect.

During a whole growth process, the feed corn plants of the test group treated with the water emulsion containing the higher fatty alcohol of the present disclosure has no rust disease and pest damage; and an appearance shows that a plant type is taller, and a colour of leaves is darker and shiny. During a growth process of the feed corn plants of the comparison group, an appearance of the feed corn plants is obviously weaker in the growth vigour, insect pests of corn plant borer, corn plant aphids and the like are found, and a damage rate of the insect pests is 13.2%.

In a face of continuous high temperature and less rain weather, the feed corn plants of the test group maintains normal growth and vitality, while the feed corn plants of the comparison group shows obvious water shortage symptoms and weak vitality.

TABLE 6
a result of the water emulsion containing the higher fatty alcohol
of the present disclosure using in the feed corn plants

| serial | | test | |
|---|---|---|---|
| number | item | group | comparison group |
| 1 | insect pest | no | corn plant borer and corn |
| | | | plant aphids are found, |
| | | | and the damage rate of the |
| | | | insect pests is 13.2%. |
| 2 | average plant height (cm) | 378.2 | 315.9 |
| 3 | average basal culm | 4.1 | 3.2 |
| | thickness (cm) | | |
| 4 | Average single plant | 2.01 | 1.61 |
| | weight (kg) | | |
| 5 | Average biological yield | 6533 | 4854 |
| | per mu (kg) | | |

During the whole growth process, the feed corn plants of the test group treated with the water emulsion containing the higher fatty alcohol of the present disclosure has no rust disease and pest damage, taller plant type, darker and glossy leaves color, and drought resistance; and an increase rate of biological yield reaches 34.6%.

It can be seen from Example 5 that using the water emulsion containing the higher fatty alcohol of the present disclosure diluted with water to treat the corn plants, the transcription levels of genes associated with the synthesis pathways of cutin, wax, and jasmonic acid in the metabolic pathways of the corn plants can be significantly affected. The use effects in the field production of Example 6 and Example 7 show that by using the water emulsion containing the higher fatty alcohol of the present disclosure, the diseases and insect pests of the corn plants can be effectively reduced, a growth capacity of the corn plants in a drought environment can be improved, and the quality and yield can be improved.

Combining Example 5, Example 6 and Example 7, it can be seen that using the water emulsion containing the higher fatty alcohol of the present disclosure to the corn plants, the synthesis pathways of cutin, wax, and jasmonic acid in the metabolic pathways of the corn plants can be significantly affected; and in an actual agricultural production, the rust disease resistance and insect resistance, the drought resistance, and the quality and yield of the corn plants can be effectively improved.

The above are merely some embodiments of the present disclosure, cannot be construed to limit the present disclosure. Any changes, modifications, alternatives and variations can be made in the embodiments without departing from the scope of the present disclosure, but these all fall into the protection scope of the present disclosure.

1. Use of a higher fatty alcohol in preparing a preparation for increasing transcription levels of genes associated with a synthesis pathway of jasmonic acid of corn plants, wherein, a use in an aspect of preventing insect pests of the corn plants is achieved by increasing the transcription levels of genes associated with the synthesis pathway of the jasmonic acid of the corn plants through the higher fatty alcohol.

2. The use of claim 1, wherein the higher fatty alcohol is one of dodecanol and cetyl alcohol or a mixture of dodecanol and cetyl alcohol.

3. The use of claim 2, wherein the preparation is a water emulsion, and the water emulsion comprises the higher fatty alcohol, an emulsifier, a thickener and water.

4. Use of a higher fatty alcohol in preparing a preparation for increasing transcription levels of genes associated with synthesis pathways of cutin and wax of corn plants, wherein, a use in an aspect of reducing erosion of pests and diseases is achieved by increasing the transcription levels of genes associated with the synthesis pathways of the cutin and the wax through the higher fatty alcohol.

5. The use of claim 4, wherein the higher fatty alcohol is one of dodecanol and cetyl alcohol or a mixture of dodecanol and cetyl alcohol.

6. The use of claim 5, wherein the preparation is a water emulsion, and the water emulsion comprises the higher fatty alcohol, an emulsifier, a thickener and water.

7. Use of a higher fatty alcohol in preparing a preparation for increasing transcription levels of genes associated with synthesis pathways of cutin and wax of corn plants, wherein, a use in an aspect of increasing a yield of the corn plants is achieved by increasing the transcription levels of genes associated with the synthesis pathways of the cutin and the wax through the higher fatty alcohol.

8. The use of claim 7, wherein the higher fatty alcohol is one of dodecanol and cetyl alcohol or a mixture of dodecanol and cetyl alcohol.

9. The use of claim 8, wherein the preparation is a water emulsion, and the water emulsion comprises the higher fatty alcohol, an emulsifier, a thickener and water.

10. Use of a higher fatty alcohol in preparing a preparation for increasing transcription levels of genes associated with synthesis pathways of cutin and wax of corn plants, wherein, a use in an aspect of drought resistance of the corn plants is achieved by increasing the transcription levels of genes associated with the synthesis pathways of the cutin and the wax through the higher fatty alcohol.

11. The use of claim 10, wherein the higher fatty alcohol is one of dodecanol and cetyl alcohol or a mixture of dodecanol and cetyl alcohol.

12. The use of claim 11, wherein the preparation is a water emulsion, and the water emulsion comprises the higher fatty alcohol, an emulsifier, a thickener and water.

13. Use of a higher fatty alcohol in preparing a preparation for increasing transcription levels of genes associated with synthesis pathways of cutin and wax of corn plants, wherein, a use in an aspect of rust disease resistance of the corn plants is achieved by increasing the transcription levels of genes associated with the synthesis pathways of the cutin and the wax through the higher fatty alcohol.

14. The use of claim 13, wherein the higher fatty alcohol is one of dodecanol and cetyl alcohol or a mixture of dodecanol and cetyl alcohol.

15. The use of claim 14, wherein the preparation is a water emulsion, and the water emulsion comprises the higher fatty alcohol, an emulsifier, a thickener and water.
